(19) United States
(12) Patent Application Publication
(10) Pub. No.: US 2010/0214952 A1
(43) Pub. Date: Aug. 26, 2010

(54) SYSTEM AND METHOD FOR ORGANIZING A NETWORK

(76) Inventors: Mark Gallagher, Berkshire (GB); James Michael Murphy, Alameda, CA (US)

Correspondence Address: FOLEY & LARDNER LLP, P.O. BOX 80278, SAN DIEGO, CA, 92138-0278, US

(21) Appl. No.: 12/712,135

(22) Filed: Feb. 24, 2010

Related U.S. Application Data
(60) Provisional application No. 61/155,465, filed on Feb. 25, 2009.

(51) Int. Cl. H04L 12/28

(52) U.S. Cl. 370/254

(57) ABSTRACT

Methods, apparatus and computer program products for providing an autonomously organizing network enable a cellular network to maintain stable operation despite unpredictable addition or removal of network devices. In addition, a network operator can create a scalable deployment that provides for operational efficiency and reduced cost burden of new equipment by enabling many existing processes to remain relevant. A method for providing such a network provides for collecting radio data from a first peer device, collecting topological data from the first peer device or a second peer device, creating a message from the topological and the radio data, and sending the message to a network device.

### CROSS REFERENCE TO RELATED APPLICATION(S)

The present application claims priority to U.S. Provisional Patent Application Ser. No. 61/155,465, entitled “Autonomously Organizing Cellular Network And Method For Providing The Same”, filed Feb. 25, 2009, the entirety of which is hereby incorporated by reference.

### FIELD OF INVENTION

The present invention relates to communication networks, and more particularly, some embodiments relate to autonomously organizing cellular networks.

### BACKGROUND

This section is intended to provide a background or context to the disclosed embodiments. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Femtocells or Access Point Base Stations are small cellular base stations typically used in buildings, residential environments, or locations with limited lines of sight to nearby antennae. Femtocells enable multiple mobile phones within range to connect to a cellular network through a broadband connection. The primary focus of technical innovation described in the literature has been on the way that these small base stations interact with the radio environment, for example overcoming interference issues between multiple femtocells. Typically, a femtocell network is designed analogously to that of a cellular network using large base station antennae.

In many cellular systems, the logical architecture is planned according to specific and detailed standards that impose a relatively inflexible choice of network elements, equipment, and interfaces between elements. Additionally, the number of network devices is small enough that an individual, or very small group of individuals, with a simple set of guidelines can centrally plan the complete cellular system architecture and resulting deployment. Due to the constrained and well-defined number of network elements, typically less than 50,000, the resulting architecture will, in general, perform precisely according to the design. These architectures will typically be based upon a ‘repeated pattern’ imposed by complying with the written generally available and acceptable standard.

### SUMMARY OF THE EMBODIMENTS OF THE INVENTION

According to various embodiments of the invention, a system and method for providing an autonomously organizing network enables a cellular network to maintain stable operation despite unpredictable addition or removal of network devices.

The method and apparatus of the disclosed embodiments allow a network operator to create a scalable deployment that provides for operational efficiency and reduced cost burden of new equipment by enabling many existing processes to remain relevant with substantial equipment volumes, potentially in the millions, being installed.

This method is very scalable and could allow individual cellular network architectures to grow quickly to potentially millions of network elements and associated connected interfaces via the management of a constrained set of rules and goals for the resulting topology/system architecture and is robust to network elements being added or deleted such that the architecture can evolve in real-time.

The method proposed allows each base station to be dynamically commissioned (i.e. brought online) at a time suited to the circumstances of the installation rather than a centrally desired time horizon. Secondly, the characteristics on the commissioning process can be adaptive and responsive to the prevailing network connectivity methods, system topology, traffic load as well as special parameters such as the RF environment and architecture security. Thirdly, for example, as adjacent or dependent nodes are commissioned the base station can adjust its logical connectivity parameters to accommodate the prevailing conditions such that hundreds, thousands or potentially millions of base stations can be deployed and efficiently and adaptively incorporated into the system architecture.

The disclosed embodiments are scalable such the base station equipments can create and maintain a optimized architecture according to the initial commissioning rules and parameters transferred, plus subsequent information passed through the architecture as it expands with additional nodes, contracts as network elements are decommissioned or via operator or user intervention.

An embodiment presents a method for providing a cellular network comprised of a plurality of network devices. The method comprises collecting radio data from a first peer device, collecting topological data from the first peer device or a second peer device, creating a message from the topological and radio data, and sending the message to a network device.

A further embodiment further provides that the network device to which the message is sent is the first or second peer device.

A further embodiment provides that the network device to which the message is sent is a third peer device.

A further embodiment provides that the step of sending the message comprises sending the message to a plurality of network devices.

A further embodiment provides that the method further comprises obtaining a behavior metric, and provides that the step of creating the message comprises evaluating the behavior metric.

A further embodiment provides that the behavior metric is determined pursuant to an operation strategy.

A further embodiment provides that the step of obtaining comprises deriving the behavior metric.

A further embodiment provides that the step of obtaining comprises receiving the behavior metric.

A further embodiment provides that the radio data comprises radio link data or radio signal data.

A further embodiment provides that the topological data comprises data derived from a message provided by a peer device of the first or second peer device, or a topologically-farther device.

A further embodiment provides that the method further comprises discarding some of the radio or topological data pursuant to a rule.

A further embodiment provides that the message comprises data regarding received radio data, intrinsic radio capabilities, received topological data, or intrinsic topological capabilities.

A further embodiment provides that the intrinsic topological capabilities or the intrinsic radio capabilities comprise current or anticipated operational data, current or anticipated operational system load, current or anticipated transmission data, or current or anticipated transmission bandwidth.

A further embodiment provides that the method further comprises obtaining an address based on the message.

A further embodiment provides that the method further comprises obtaining a routing procedure based on the address and received network device addresses; and sending a transmission based on the routing procedure.

A further embodiment provides that the step of obtaining a routing procedure comprises generating a weighted table of network device data.

A further embodiment provides that the step of obtaining a routing procedure comprises receiving the routing procedure from a network device, wherein the network device maintains a weighted table of network device data.

A further embodiment provides that the method further comprises monitoring the network devices and modifying the behavior metric pursuant to a strategy.

An additional embodiment provides a peer to peer network device comprising a transmitter, a receiver; and a controller coupled to the receiver and configured to receive peer device radio data and peer device network data, and further configured to cause the transmitter to communicate radio capability data and topological network data at least one other network device.

A further embodiment provides that the other network device is a peer device.

A further embodiment provides that the at least one other network device is a plurality of network devices.

A further embodiment provides that the controller is further configured to apply a behavior metric to transmit the radio capability data and the topological network data.

A further embodiment provides that the application of the behavior metric comprises discarding a portion of the radio capability data or the topological network data pursuant to a rule.

A further embodiment provides that the radio capability data and topological network data is encoded in a message having a format.

A further embodiment provides that the controller is further configured to receive a plurality of messages encoded with network data from a plurality of other network devices and to transmit the message to at least one further network device.

A further embodiment provides that the at least one further network device is an exterior entity.

A further embodiment provides that the exterior entity is a gateway.

A further embodiment provides that the controller is further configured obtain an address and to obtain addresses of other network devices.

A further embodiment provides that the controller is further configured to obtain a routing procedure based on the radio data and the network data.

A further embodiment provides that the controller is further configured to provide the routing procedure to a network device.

A further embodiment provides that the controller is further configured to receive a routing procedure.

An additional embodiment provides a network system comprising a plurality of network devices in communication, wherein a network device is configured to collect radio data from a first peer device, collect topological data from the first peer device or a second peer device, create a message from the topological and radio data, and send the message to a further network device.

A further embodiment provides that the further network device is the first or second peer device.

A further embodiment provides that a network device is configured to send the message to a plurality of network devices.

A further embodiment provides that the system further comprises an intermediate network device configured to receive a plurality of messages encoded with network data from a plurality of other network devices and to transmit the message to at least one further network device.

A further embodiment provides that the system further comprises at least one exterior entity in communication with at least one of the network devices and configured to enable the network system to communicate with an exterior network.

A further embodiment provides that the exterior entity is a gateway.

A further embodiment provides that the plurality of network devices are further configured to obtain an address and to obtain addresses of other network devices.

A further embodiment provides that at least one of the network devices is further configured to create a routing procedure based on received messages pursuant to a behavior metric.

A further embodiment provides that the network device or devices configured to create a routing procedure are further configured to transmit the created routing procedure to the remaining network devices of the system.

A further embodiment provides that the network device is configured to evaluate a behavior metric to create the message.

A further embodiment provides that the behavior metric is defined to evaluate operational behavior for conformance with an operational strategy.

A further embodiment provides that the behavior metric is provided to a proper subset of the plurality of network devices.

A further embodiment provides that the behavior metric is applied to the proper subset to determine conformance with the operational strategy, and wherein the behavior metric is adjusted or provided to further network devices pursuant to the result of the evaluation.

An additional embodiment provides a computer program product comprising computer program code embodied in a computer useable medium and enabling a network device to perform the functions of collecting radio data from a first peer device, collecting topological data from the first peer device or a second peer device, creating a message from the topological and radio data, and sending the message to a network device.

A further embodiment provides that the computer program product further enables a network device to perform the function of receiving a behavior metric, and wherein the function of creating comprises applying the metric.

A further embodiment provides that the computer program product further enables a network device to perform the function of obtaining an address based on the message.

A further embodiment provides that the computer program product further enables a network device to obtain a routing procedure based on the address and received network device addresses, and send a transmission based on the routing procedure.

A further embodiment provides that the obtaining a routing procedure comprises receiving the routing procedure from a network device, wherein the network device maintains a weighted table of network device data.

An additional embodiment provides a method of modeling a cellular network, comprising obtaining radio data of a first peer device, obtaining topological data of the first peer device or a second peer device, obtaining a behavior metric, and applying the behavior metric to the radio data and topological data to create a model of the cellular network.

A further embodiment provides that modeling the cellular network further comprises evaluating the model pursuant to an operation strategy.

A further embodiment provides that modeling the cellular network further comprises adjusting the behavior metric pursuant to the results of the evaluation, and applying the adjusted behavior metric to the radio data and topological data to create a second model of the cellular network.

A further embodiment provides that modeling the cellular network further comprises providing the behavior metric to a network device.

A further embodiment provides that modeling the cellular network further comprises obtaining an address of the first or second peer device.

A further embodiment provides that modeling the cellular network further comprises generating a routing procedure for the model.

A further embodiment provides that modeling the cellular network further comprises providing the routing procedure to a network device.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates an exemplary network architecture according to an embodiment of the invention.

FIG. 2 illustrates the logical peer-to-peer arrangement of the embodiment described in FIG. 1.

FIG. 3 illustrates a method for identifying and associating a received signal with the signal's corresponding sending device according to an embodiment of the invention.

FIG. 4 illustrates an example base station or access point according to an embodiment of the invention.

FIG. 5 illustrates an example environment in which an embodiment of the invention may be implemented.

FIG. 6 illustrates methods of information and message distribution according to an embodiment of the invention.

FIG. 7 illustrates an method for maintaining a network architecture and resulting topology according to an embodiment of the invention.

FIG. 8 presents an example process flow for message advertising according to an embodiment of the invention.

FIG. 9 is an example of how the message's field ‘hop count’ is amended as it flows across other nodes according to an embodiment of the invention.

FIG. 10 illustrates a communications system implemented in accordance with one exemplary embodiment of the invention.

FIG. 11 illustrates an exemplary base station which may be, for example, an access router, implemented in accordance with an embodiment of the invention.

FIG. 12 illustrates an exemplary wireless terminal, e.g., a mobile node (MN) implemented in accordance with an embodiment of the invention.

FIG. 13 illustrates an exemplary intermediate network device according to an embodiment of the invention.

FIG. 14 illustrates an example embodiment of the invention where the messages propagating through the system are centrally processed and redistributed.

FIG. 15 shows a series of steps where new nodes are added to the system and parameters are changed to show how an embodiment of the invention may operate in an example deployment.

FIG. 16 provides an exemplary SGSN according to an embodiment of the invention.

FIG. 17 provides an exemplary MSC according to an embodiment of the invention.

FIG. 18 provides an exemplary controller according to an embodiment of the invention.

FIG. 19 provides an exemplary secure router according to an embodiment of the invention.

FIG. 20 provides an example of a data table according to an embodiment of the invention.

FIG. 21 illustrates an example message according to an embodiment of the invention.

FIG. 22 highlights how the various processes and methods described herein could be assembled to create a single process according to an embodiment of the invention.

FIG. 23 is a process flow illustrating a method of network creation within the operational processes typically found in the mobile operator according to an embodiment of the invention.

FIG. 24 illustrates an example computing module for use in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF CERTAIN EMBODIMENTS

In the following description, for purposes of explanation and not limitation, details and descriptions are set forth in order to provide a thorough understanding. However, it will be apparent to those skilled in the art that the various embodiments may be practiced in other embodiments that depart from these details and descriptions.

various disclosed embodiments enable a cellular network to maintain stable operation despite unpredictable addition or removal of network devices. A network operator may create a scalable deployment that provides for operational efficiency and reduced cost burden of new equipment by enabling many existing processes to remain relevant with substantial equipment volumes, potentially in the millions, being installed.

In order to facilitate the understanding of the disclosed embodiments, it is useful to describe a few example environments with which the various embodiments can be implemented. One such example is that of deploying a femtocell-based network within an office building to improve cellular reception and capacity. Another example is a residential neighborhood wherein the plurality of the neighborhood occupants share a specific cellular service provider and desire to improve cellular reception and capacity within the neighborhood.

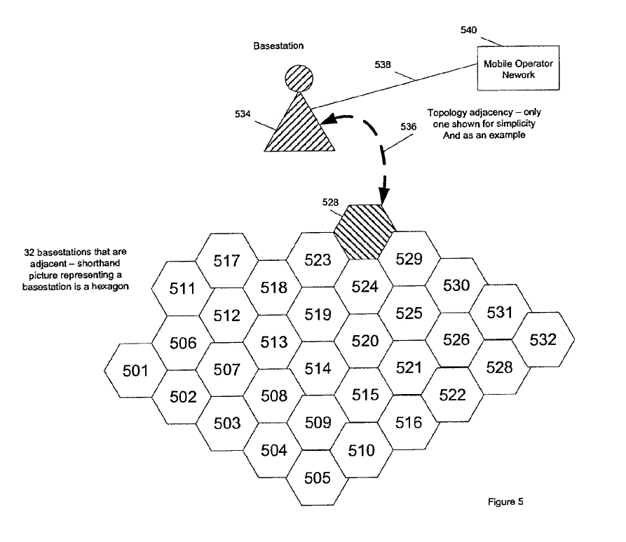

Another example is illustrated in FIG. 5. In this example, the macro node 534 (MNB) has 32 topological neighbors (elements 501-532). This topology when correctly set up, allows a mobile device, for example a cell phone, to move freely within the geographical area covered by the MNB and each of its neighbors. For simplicity of illustration, a single connection (element 538) back to the mobile network operator (element 540) is shown. In practiced embodiments, there may be other connections between the elements (501-532) and the mobile network operator (element 540).

In this environment, the operator of the MNB and its neighbors may decide to introduce 1,000 small base stations, or femtocells, to increase density and improve network coverage and capacity. The installation of the base stations may be performed by the network operator, or by the network customers, or by a mixture of the two. For example, in the installation of a number of base stations within the building, a network operator may install a central or intermediate network device at the top floor of the building. The network customers may then install a plurality of smaller base stations at various locations within the building, for example in the building lobby where a large number of mobile devices are typically operated concurrently.

From time-to-time, the disclosed embodiments are described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

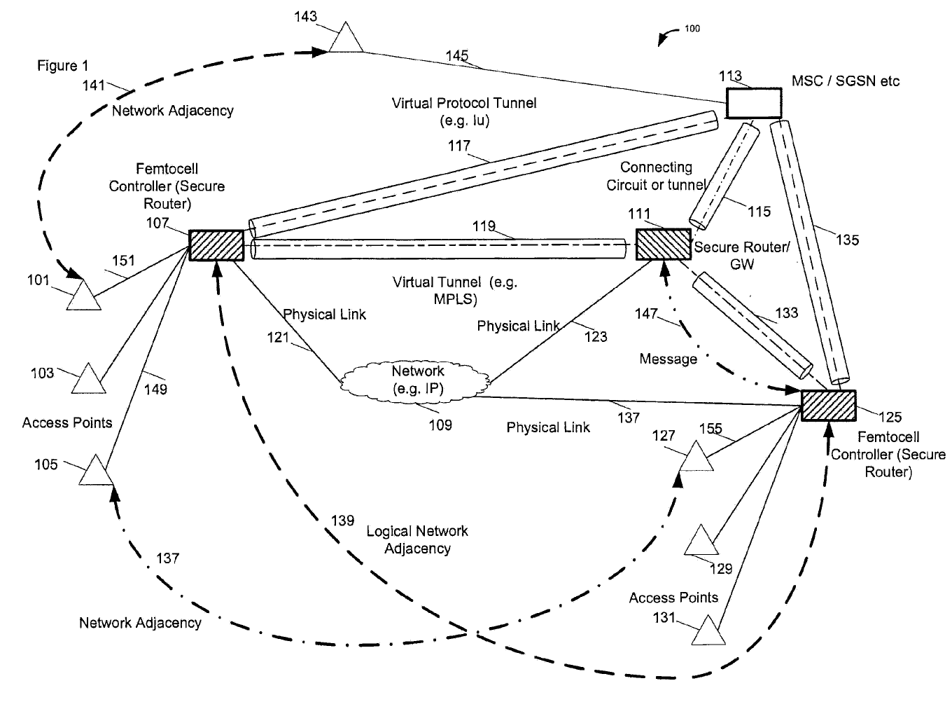

FIG. 1 illustrates an exemplary network architecture according to an embodiment of the invention. In this embodiment, network device 127 is a small base station, or access point. Base station 127 has RF transmission and reception facilities used for standards based operation.

The node is connected to the Internet, or a local network shown in connection 155 and powered-up to start operation. At this point either pre-provisioned or at-runtime information is provided such that the access point 127 can provide network service to wireless devices, such as mobile devices (not shown), attached across an air interface or wireless interface.

In this figure, the access point 127 and a connecting network device element 125 are illustrated. Connecting device 125 may comprise a femtocell controller. In other embodiments, connecting device 125 may be a secure router. In still other embodiments, the functionality of connecting device 125 and access point 127 may be combined in a single device. Connecting device 125 may be configured to enable a plurality of access points to connect to the network 109. For example, in FIG. 1 a simple example network comprising a small number of access points (elements 127, 129 and 131) and controller 125 are shown.

In this embodiment, controller 125 is configured to enable construction of a virtual tunnel 133 between controller 125 and network device 111 via network 109 and physical connections 137 and 123. For example, such a virtual tunnel may be constructed according to the methods described in U.S. Provisional Patent No. 61/104,989, “Method of Encapsulating Femtocell Protocol Traffic to Simplify Network Design.” In some embodiments, network device 111 may comprise a second secure router, or a gateway. In this embodiment, network device 111 may then provide an intermediate tunnel 115 to network element 113. For example, intermediate tunnel 115 may also comprise a virtual tunnel. In this embodiment, network elements 113 comprises an MSC or SGSN as described in the art. The construction of connections 133 and 115 can be created in such a way that a virtual protocol tunnel connects controller 125 and MSC or SGSN 113.

As illustrated in FIG. 1, additional network configurations and connections may be implemented. For example, base station 143 may be directly connected to MSC 113, as illustrated in connection 145. In some embodiments, this base station 143 may comprise a standard macrocell base station. As a further example, femtocell controller, or secure router, 107 may be connected to the MSC 113 via a virtual protocol tunnel 117.

FIG. 1 further illustrates a series of logical network adjacencies within the topology created by the network connections. For example, a logical network adjacency 133 exists between controller 125 and secure router 111 via connection 133. A further logical network adjacency 119 occurs between controller 107 and secure router 111 via connection 119. Adjacency example 139 is between controller 125 and 107 via connections 133 and 119 with the secure router 111 acting as a gateway. Adjacency example 137 is between access point 127 and 105 via connection 147 and secure router 125 and gateway 111 via connection 133 and secure router 107 via connection 107 and then connection 149. Adjacency example 141 is between access point 101 and base station 143 using connection 145 MSC 113 secure router 111 via connection 115 and secure router 107 via connection 119 and connection 151.

In these embodiments, messages, such as message 147, can be transmitted either directly between logically adjacent elements or via intermediate nodes as described herein. As described herein, messages can be created and transferred between network devices to establish a network architecture for data transfer. For example, messages may be created that allow specific cellular parameters, such as radio signal strength to be embedded in the message flow. Accordingly, the system can be implemented such that adjacencies created are capable of radio link data transmission between nodes in a peer to peer architecture.

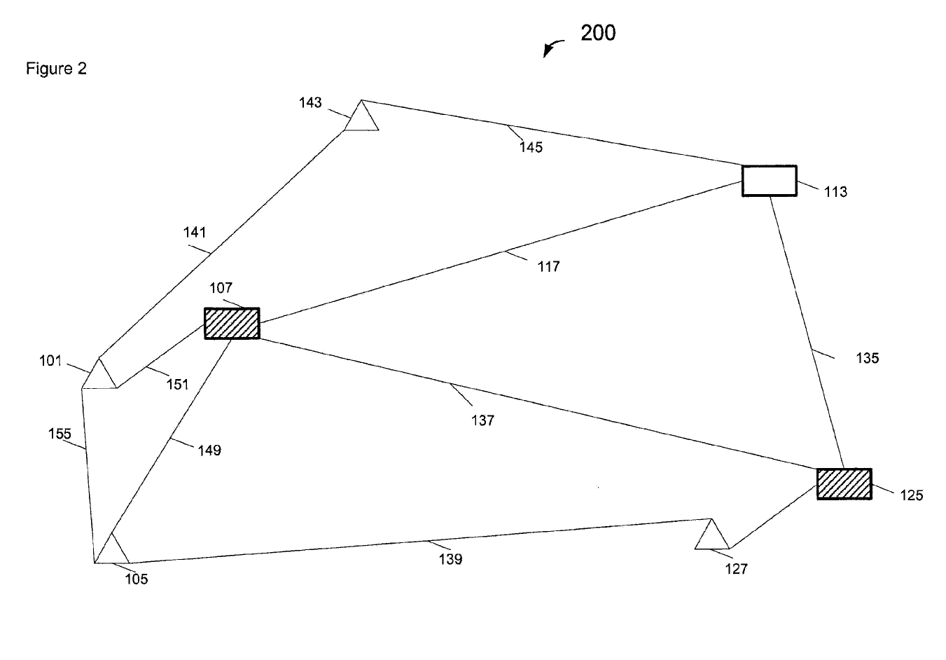

FIG. 2 illustrates the logical peer-to-peer arrangement of the embodiment described in FIG. 1. In this example, the logical peering relationships are shown as lines. The architectural topology of a typical example could be much more complex; here it is shown with a few connections for ease of discussion. Example connection 155 between devices 101 and 105 highlights an example adjacency that would exist if the controller and access point were implemented in the embodiment of a controller plus and access point, described with respect to FIG. 1. In another example, the information is shared via an intermediate peer, for example as illustrated in connection 139.

For creation of such an architecture, new functional procedures can be implemented. One such procedure establishes the peering relationships such that they can be logically recognized between the network nodes. Additional procedures maintain the network adjacencies and resulting topology and adjust the topology as new nodes are added and or existing nodes removed to the system. Other procedures may adjust the topology during operation according to available information. Such information might include network information regarding the state of the logical network, current network loading, or network device operational state, or other types of information, such as operational costs, network security, and customer subscription information. Additional procedures enable the system to interoperate with Internet-type nodes or devices. Particular embodiments may utilize methods of network addressing to provide a constituent network device with an address. For example, a particular embodiment might utilize the addressing methods described in U.S. Provisional Patent Application Ser. No. 61/107,283, filed Oct. 21, 2008, U.S. patent application Ser. No. 12/603,390, titled “ADDRESSING METHODS AND APPARATUS FOR USE IN A COMMUNICATION SYSTEM,” filed Oct. 21, 2009, and corresponding PCT application No. US09/061,557, each of which is hereby incorporated by reference in its entirety.

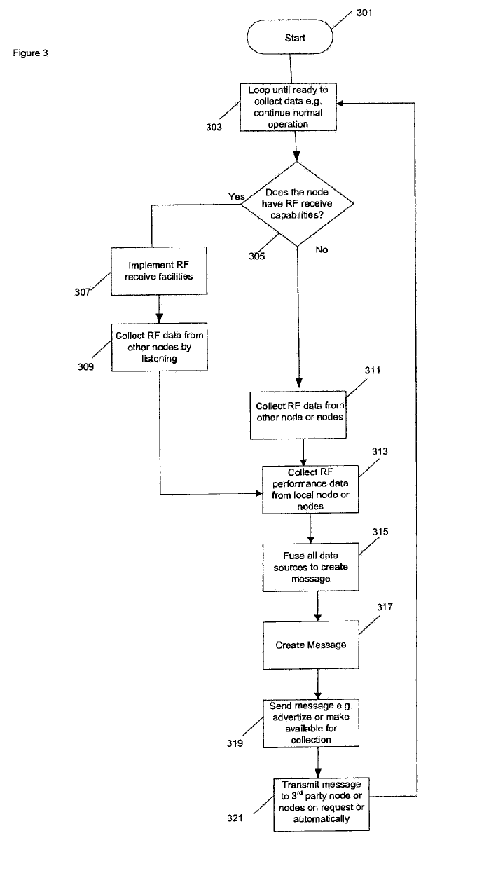

FIG. 3 illustrates a method for identifying and associating a received signal with the signal's corresponding sending device according to an embodiment of the invention. In some embodiments, this method may be employed to establish virtual network adjacencies, such as those described with respect to FIGS. 2 and 1. In various embodiments, such wireless detection can be continuous or intermittent and performed at automatic, predetermined or ad-hoc intervals. Accordingly, addition of a network device, such as a base station, to the network may be able to occur at any given time. In alternative embodiments, the wireless detection may be configured such that network device addition may only occur at a predetermined time or predetermined time intervals. In other embodiments, a helper function, node, or device may be associated with the network device such that the helper performs some or all of the radio signal processing. In still other embodiments, such a helper function may be associated with a plurality of network devices, and may perform some or all of the radio signal processing for the plurality. In some embodiments, the wireless information is stored as a set of parameters for processing or incorporation into a message that is transmitted and propagated throughout the network. In further embodiments of the invention, the network devices may be configured to protect and secure the network operator's licensed radio spectrum. For example, some or all of the network devices may be configured to perform the methods described in U.S. Provisional Patent Application Ser. No. 61/093,190 (as well as U.S. patent application Ser. No. 12/550,299, titled “SYSTEM AND METHOD FOR FEMTOCELL MANAGEMENT,” filed Aug. 28, 2009, and hereby incorporated by reference in its entirety) to protect and secure the licensed radio spectrum.

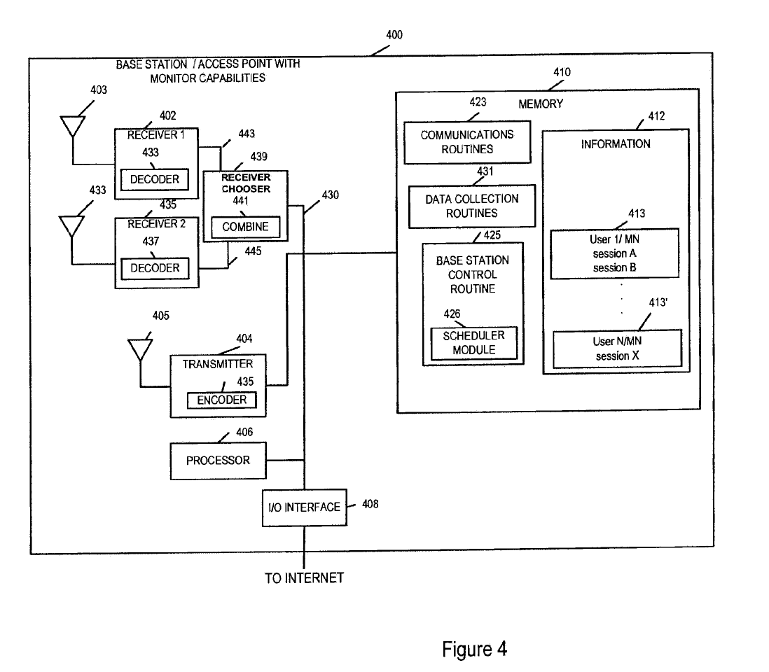

FIG. 4 illustrates an example base station or access point according to an embodiment of the invention. In the illustrated embodiment, additional receiver functions 435 are included. These receiver functions 435 may be enabled by modules 423 and 431 via element 439, as required. These receiver functions may be configured to receive intelligence and information from surrounding base stations or access points. This intelligence and information may include, for example, signal strengths, scrambling codes, system parameters, timing offsets, frequencies, etc. This information is stored for analysis in module 431.

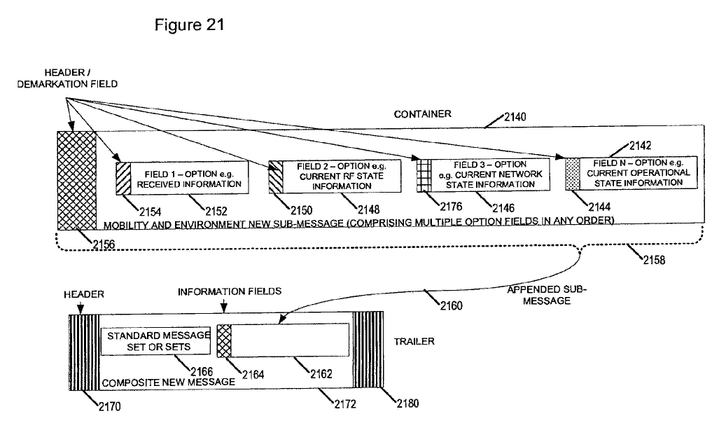

The base station 400 may be further configured to transmit local operating information in addition to retransmission of the received information. Such local operating information may include, for example, an operational load, I/O link speed, number of attached mobile devices, scrambling codes, frequency assignment, back-haul load, or weighting factors, etc., that are added to the information to provide increased set of parameters. In this embodiment, the communications routines module 423 may be configured to encode to the information stored in module 431 according to a network standard to create a network message. For example, such a network standard message is illustrated with respect to FIG. 21. In embodiments where the controller and access point are implemented as a single entity, then the whole of the combined node can be used for message creation. In embodiments where the collection is not co-located within a node, then the message creation is enabled by the current and historical information made available to the standalone collecting entity.

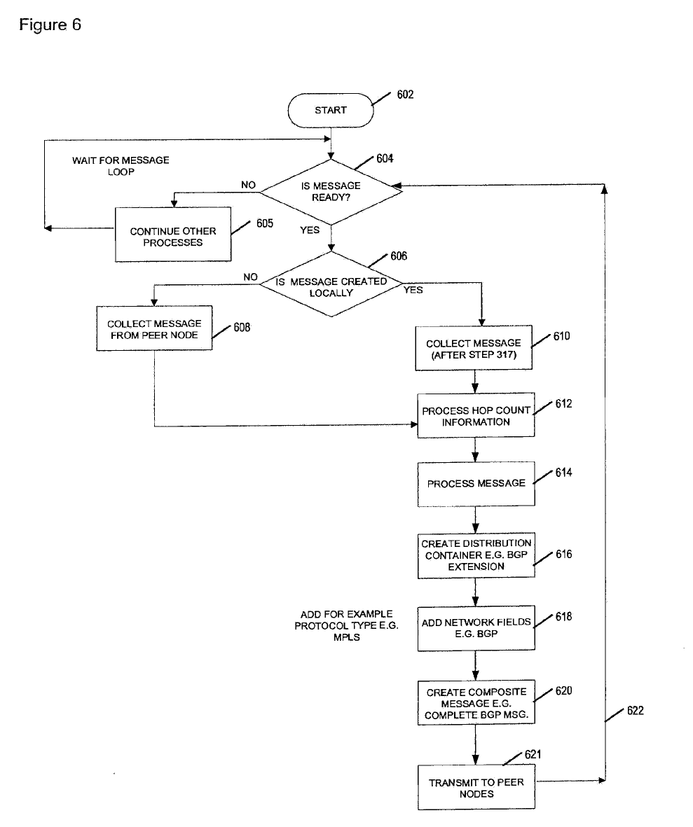

FIG. 6 illustrates methods of information and message distribution according to an embodiment of the invention. In this embodiment, the underlying distribution is based upon an extension to BGP (Border Gateway Protocol). This embodiment processes the collected radio, node parameters, and topological data, to create a new extension to BGP, thus forming a new BGP message that can be distributed locally and globally to adjacent and remote nodes. Accordingly, some embodiments may be configured to provide backwards compatibility with legacy network devices and architectures. In the illustrated embodiment, the distribution mechanism assumed is MPLS (multi-protocol label switching). Other embodiments may utilize other distribution mechanisms according to the network application. Such distribution mechanisms may include, for example, Internet protocol mechanisms, Interior Gateway Protocol (IGP) mechanisms, or mechanisms that structure the message such that IP elements can automatically recognize and process the new message to build the architecture and dynamically maintain the logical topology described in FIGS. 1 and 2.

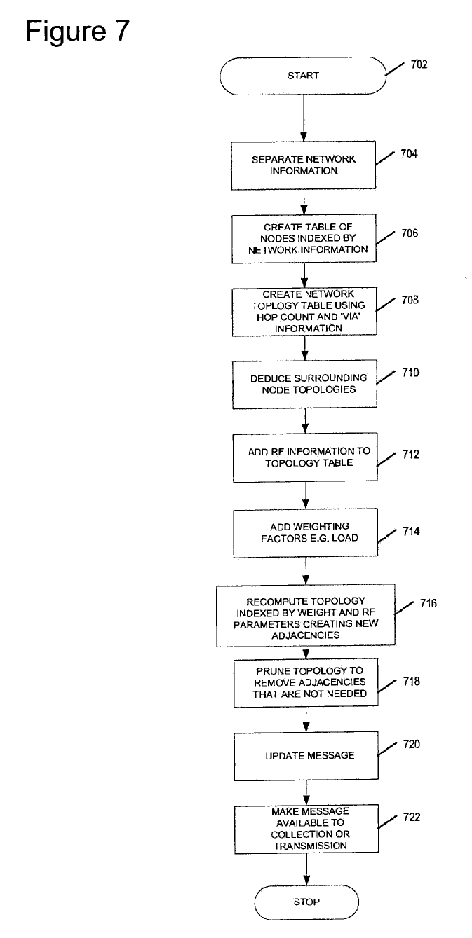

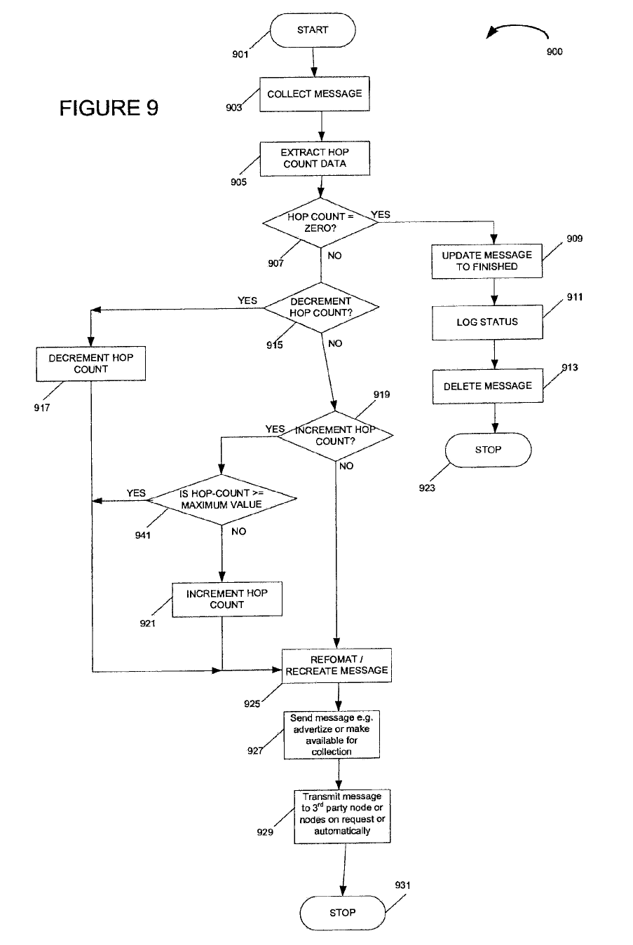

As the process described in FIG. 6 begins, the network device enters into a wait for message loop, as illustrated in blocks 604 and 605. Once the network device obtains a message, the process enters inquiry 606. If the message is not created locally, the device collects the message from the sending peer node in block 608. If the message is created locally, the device collects the message in block 610. For example, the network device may perform the methods described with respect to FIG. 3, step 317, to collect the message. In either case, after the message is collected, the hop count information is processed in step 612. For example, the network device may perform the methods described with respect to FIG. 9 to process the hop count information. After the hop count information is processed, the network device proceeds to message processing step 614. For example, the network device may perform the topological evaluation methods described with respect to FIG. 7.

In further embodiments, messages received from peers or generated locally may contain other instructions. For example, the system may be configured to allow the transmission of an instruction message for shut down of the network. In these embodiments, the step of processing the message 614 may comprise automatic shutdown. In a particular embodiment, the network device may be configured to transmit the shutdown message to receiving the peer nodes prior to shutting down, to ensure propagation of the shutdown message throughout the network.

In other embodiments, the step of processing might result in the activation of other methods or subroutines. For example, the processing step might indicate that the processing network device is a suitable network ingress or egress point. For example, the network device may identify itself as a suitable network ingress point because it has had a high available bandwidth over a certain period of time and has many outgoing topologically adjacent peers. In such an embodiment, the network device may be configured to provide this information downstream throughout the network, or may be configured to send this information directly to the network administrator.

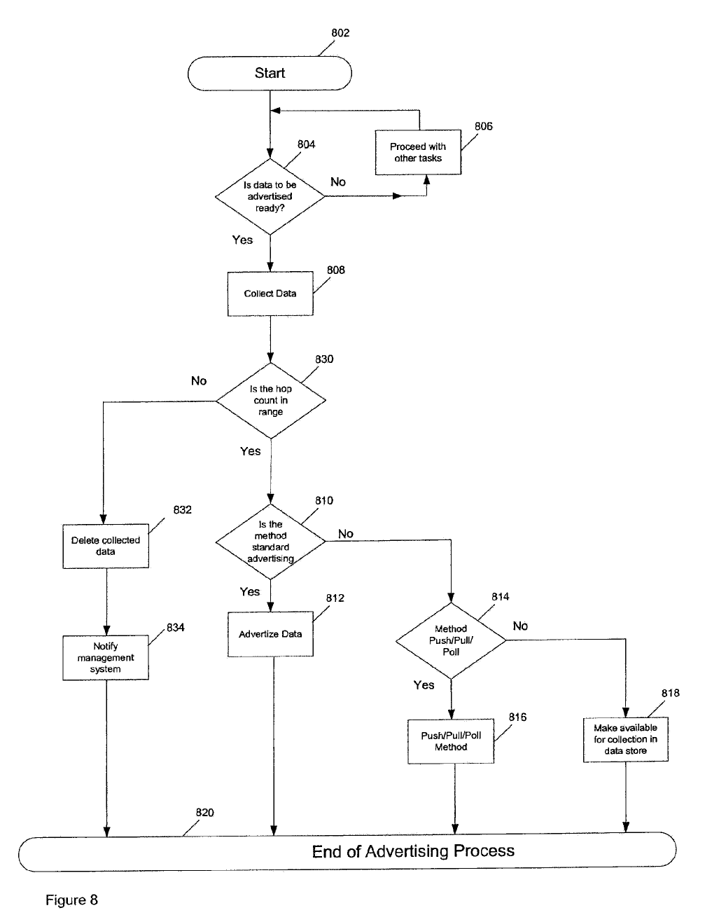

In steps 616 through 621, the network device packages the processed and generated information, into a message to transmit to other peer nodes. For example, the network device may create a message as described with respect to FIG. 21, and may transmit the message according to the methods described with respect to FIG. 8.

FIG. 7 illustrates a method for maintaining a network architecture and resulting topology according to an embodiment of the invention. In this embodiment, the method of FIG. 7 extends and further describes message processing step 614 of the method illustrated in FIG. 6. As described herein, such a received message may comprise information regarding a plurality of topologically connected network devices. In some embodiments, a plurality of network devices may be deployed in a network wherein each network device is given a predetermined address and a predetermined routing procedure. In such embodiments, this method may be performed to adjust the network connections and routing procedures according to a network operating strategy. In other embodiments, a plurality of network devices may be deployed in a network wherein each network device autonomously obtains an address and routing procedure. In such embodiments, this method may be performed to create the initial routing procedure, and may also be performed to adjust the routing procedures as the operating characteristics of the network change.

In step 704, the network information about the network devices of the plurality contained within the received message is separated or organized according to network device. In step 706, a table of nodes or network devices, indexed by network information, is created. In step 708, the table is populated using further network information. For example, the message may contain a hop count and a list of which devices have received the particular message. Accordingly, this hop count and “via” information may be used to populate the table with network topology data.

In step 710, the processing network device may use the network topology data to deduce its surrounding topology, and the topology of its peers. In some embodiments, this deduction may extend to a predetermined network connection. For example, some of the network devices may be configured to deduce only the topology of their directly connected peers. In this embodiment, other network devices may be configured to also deduce the topology of peers connected by one or more intermediate nodes or network devices.

In step 712, the network device further populates the table with radio information. In step 714, the network device populates or assigns weighting factors to various table entries. These weighting factors may vary and be chosen according to an operational strategy. Such weighting factors may include, for example, resource costs, licensed radio frequencies, spatial adjacencies, network traffic strategies (which may be predetermined), device load, and radio signal strength. For example, where the operational strategy is chosen for fast data transfer, the network device may assign a preferential weighting factor to a first peer network device that has a greater available bandwidth than a second peer network device. As another example, where the operational strategy is further chosen for operational stability, the network device may further assign preferential weighting factors to those peer network devices that have a high radio signal strength. In other embodiments, the received messages may also contain information regarding network fault events. In such embodiments, a network device may be configured such that it eliminates the faulty network device from its table.

In step 716, the network device evaluates its local topology according to the added weighting factors and radio information. In step 718, the network device removes topological adjacencies and adds new topological adjacencies according to the results of the evaluation. For example, if a network device was previously topologically adjacent to a first central node and the network device determines that the first central node has subsequently been placed under a higher data load, the network device may reevaluate its topology such that it changes its topological adjacency to a second central node. As another example, if the network device receives a fault message from its current peer, it may adjust its local topology to remove that peer. In this example, a network device may be further configured to transmit the fault message along with its message, to alert the network or network administrators of the faulty device. In step 720, the network device updates its message according to the topological adjustments performed in step 718. In step 722, this updated message is made available for collection by other network devices, or is transmitted to other network devices, as described herein.

FIG. 8 presents an example process flow for message advertising according to an embodiment of the invention. This embodiment extends the embodiment in FIG. 6 to allow nodes or devices to automatically request information and autonomously present information for system wide adoption. In this embodiment, the underlying BGP flows allow advertised messages to propagate throughout the system. Element 830 shows the parameter propagation limit as a ‘hop count’ being checked so that the transmitted information does not propagate indefinitely and affect systems where no network adjacency is possible or desired. Flow steps 810 and 814 illustrate three example methods of distributing a message. In process 812, the message and data are actively advertised. In process 816, the data is transmitted via a pull, a poll, or a push method. In process 818, the data is made available for collection.

FIG. 9 is an example of how a message ‘hop count’ may be altered as it flows across other nodes according to an embodiment of the invention. A message hop count may be implemented to provide a timer or iterative value that allows the message to expire and be removed from the system. In an example embodiment employing a message is described herein with respect to FIG. 21, the hop count may be contained in element 2146 relating to network information. In other embodiments, it may be placed in element 2142 or within headers or demarcation fields, for example, element 2156 or 2176. In still further embodiments, it may be associated with standard information field 2166, or it may be contained in a trailer present in any field message or sub-message, for example, such as trailers 2180. Alternatively, it may be a standard piece of information within information container 2140, as described with respect to FIG. 21.

In steps 907, 909, 911, 913, and 923, FIG. 9 illustrates how the message may be deleted after the hop count has reached a predetermined value, in this case zero. In other embodiments, this predetermined value may be modified according to network application. For example, in a network deployment in a building, the network operator may be aware that any message transmitted through a network device deployed on the bottom floor will require, for instance, twelve message hops to reach the outgoing network device. Accordingly, the predetermined value for the device deployed on the bottom floor may be set at twelve because it may be presumed that any message received with a hop count less than twelve will fail to reach the exterior network.

In further embodiments, the network device may be configured to increment, decrement, or allow the hop count to remain constant according to network application. For example, in a subnetwork deployed in a building network of a network deployed in a city, messages originating from devices within the building may contain a signal that instructs the building network devices not to modify that message's hop count. Accordingly, all messages originating within the building will have equal status within the network.

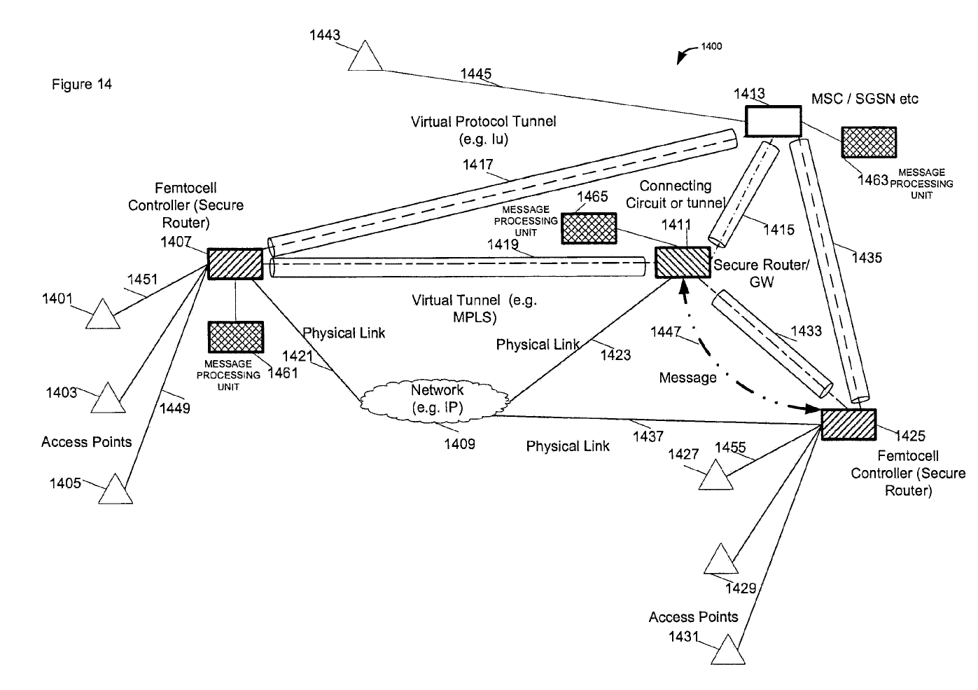

FIG. 14 illustrates an example embodiment of the invention where the messages propagating through the system are centrally processed and redistributed. In this embodiment, the central processing is conducted by adjunct module network device 1465 connected to secure router 1411. In this embodiment, the connection to the central location element 1411 may comprise a communication channel such as an Internet protocol or Ethernet channel.

In alternative embodiments, adjuncts network device 1465 may be connected at alternative places within the network, as illustrated by elements 1463 and 1461. In other embodiments, the central processing element or device may be deployed in several locations to provide distributed processing capabilities. For example, each femtocell controller or secure router in the network may be provided with a corresponding message processing unit. Accordingly, legacy networks or architectures may be upgraded with the networking capabilities disclosed herein. In additional embodiments, a message processing unit or adjunct module network device may be connected directly to an access point, or plurality of access points. For example, a single message processing unit might be deployed to connect to some or all of access points 1427, 1429, and 1431.

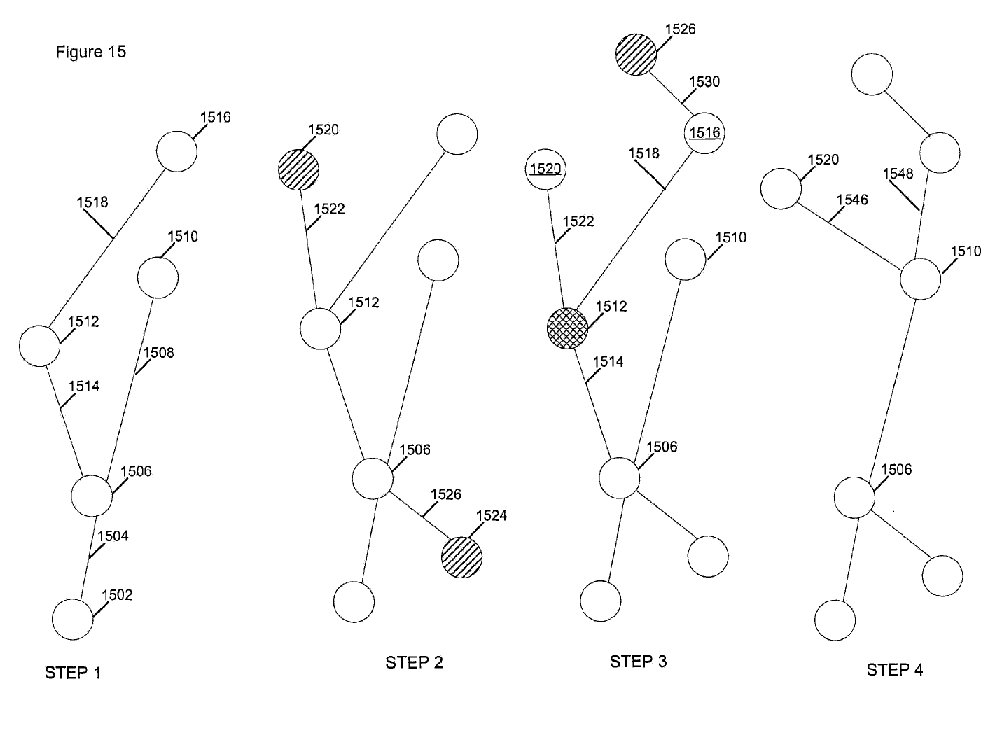

FIG. 15 illustrates a sequential series of network topologies that occur as network nodes are added or deleted from the system, to illustrate how an embodiment of the invention may operate in an example deployment. Step 1 illustrates a plurality of nodes and connections prior to the addition or deletion of any further nodes, for example, nodes 1516, 1512, 1510, 1506, and 1502, and connections 1518, 1514, 1508, and 1504. In step 2, nodes 1520 and 1524 are added to the network, creating connections 1522 and 1526, respectively. For example, nodes 1520 and 1524 may provide messages advertising their radio capabilities and topological data, as described herein, to receiving nodes 1512 and 1506, respectively. Accordingly, nodes 1520 and 1524 may be incorporated into the network architecture through the propagation of these messages throughout the network. In steps 3, node 1528 is deleted while node 1526 is added. Node 1526 may be added to the network as described with respect to nodes 1520 and 1524. Alternatively, node 1526 may be added to the network according to any other method described herein. In some embodiments, node 1512 may be configured to alert its peer nodes of its impending removal from the network. For example, node 1512 may be configured to send a message to nodes 1520, 1516, and 1506 to inform the nodes that the network topology will be changing. In these embodiments, nodes 1520, 1516, and 1506 may enter a new state, for example a reception state where inquiries for new peer nodes are sent at a greater rate. In other embodiments, the nodes may be configured such that such a message from node 1512 is unnecessary. For example, upon the removal of node 1512, nodes 1520 and 1516 may send messages, as described herein, to node 1510, forming connections 1546 and 1548. Accordingly, the final topology after such a deletion and addition is as illustrated in step 4.

In various embodiments, the referenced nodes in FIG. 15 may represent various network devices. For example, nodes 1512 and 1510 may represent a central or intermediate node that is configured to have a plurality of incoming connections and to funnel these connections to an outgoing network device. For example, node 1512 may have a greater bandwidth than nodes 1516 and 1520, allowing transmissions sent by nodes 1516 and 1520 to be transmitted without time or data loss. In such an embodiment, upon deletion of node 1512, nodes 1520 and 1516 may be configured such that new connections are preferentially formed to another central or intermediate node, for example node 1510.

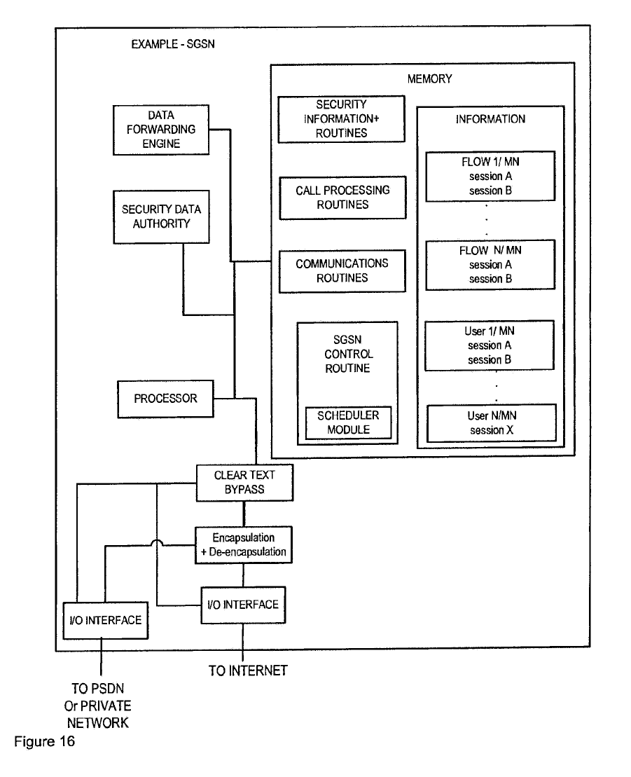

FIG. 16 provides a conventional SGSN according to an embodiment of the invention. In some embodiments, such an SGSN may be modified to perform various functions or processes, as described herein. For example, the SGSN may maintain the routing procedures derived from the propagation of messages throughout the network.

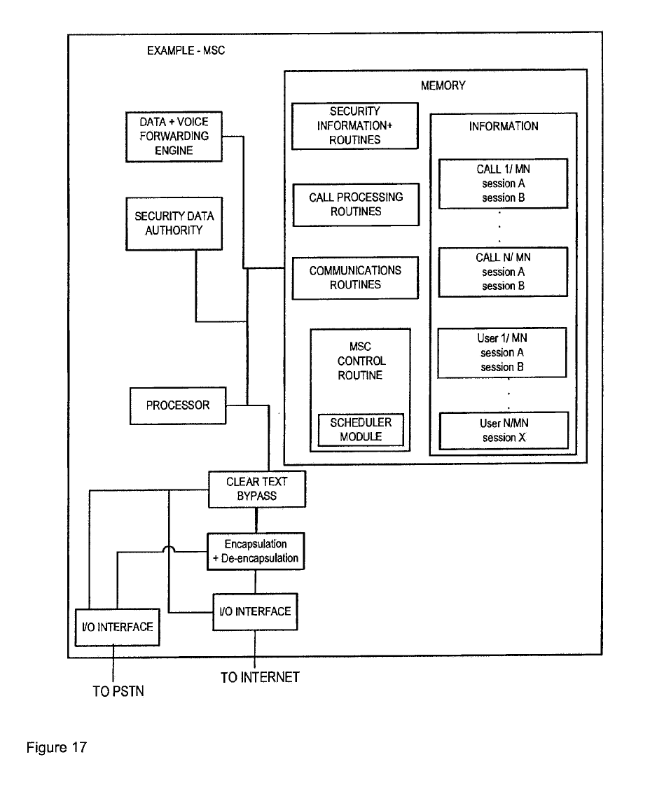

FIG. 17 provides an conventional MSC according to an embodiment of the invention. In some embodiments, such an MSC may be modified to perform various functions or processes, as described herein. For example, the MSC might be configured to collect and maintain network operational statistics derived from the propagation of messages throughout the network.

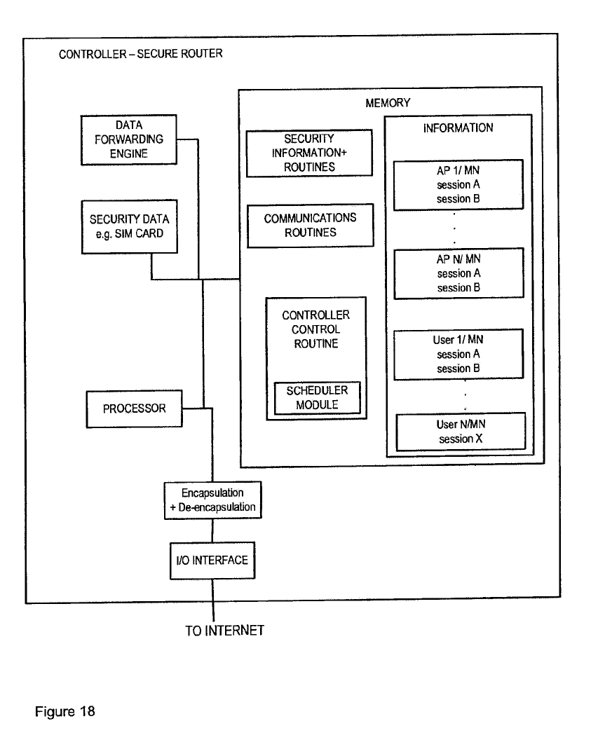

FIG. 18 provides a conventional controller according to an embodiment of the invention.

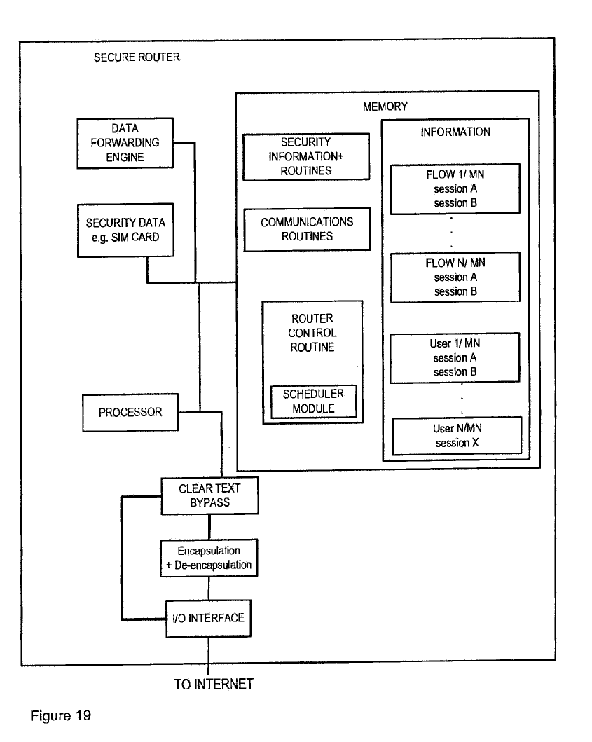

FIG. 19 provides a conventional secure router according to an embodiment of the invention.

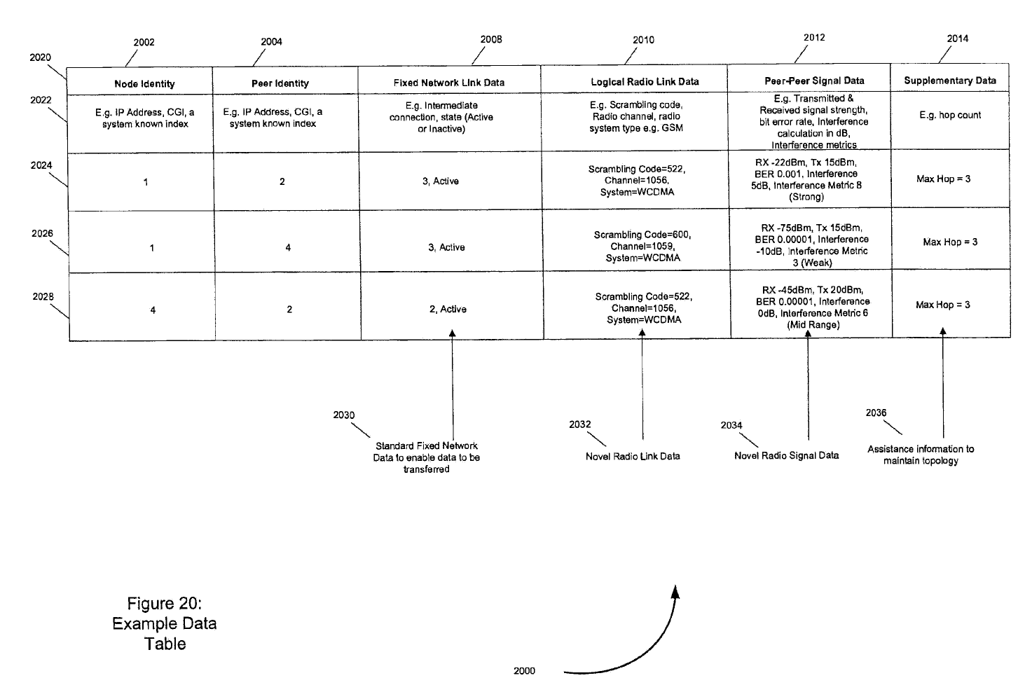

FIG. 20 provides an illustrative data table for use by various embodiments of the invention. In a particular example, such a data table may be created according to the methods described regarding FIG. 7. In the illustrated embodiment, columns 2002 and 2004 contain node identities of adjacent peers. For example, row 2028 illustrates that node 4 is topologically adjacent to node 2. Column 2008 provides the fixed network topology and reachability information. For example, row 2026 illustrates that node 1 is topologically adjacent to node 4 via fixed network link to node 3. Row 2028 illustrates that node 4 is topologically adjacent to node 2 via a direct radio link. Column 2010 provides logical radio link data. In the illustrated embodiment, this data includes the radio channel used or frequency of operation, the scrambling code used and observed, and whether the system is 3G or WCDMA. Column 2012 provides the radio signal information observed on the link. In this embodiment, the radio signal information includes the received and transmitted signal power, bit error rates at the receiver, and a calculated interference signal and an interference metric in this example rated weak (0) to very strong (10). Column 2014 contains supplementary information that may be utilized in propagating the information between the peer nodes and across the system.

Various embodiments of the invention may utilize different sized data tables according to the application. In some embodiments, for example in a central controlling embodiment, the table may contain a complete listing of all topological and peer relationships. In other embodiments, a data table might be restricted, for example, to information about the network devices that require a message hop count of 4 to reach.

In some embodiments, such a data table may be used to create a routing procedure. For example, in embodiments where a data table is centrally managed, the routing procedure may be created by the central management device and distributed throughout the network. Alternatively, in embodiments where the data table is distributed throughout the network, each network device or a plurality of subsets of network devices may create a local routing procedure according to the information from the data table. In further embodiments, the routing procedures may be modified to provide selective routing of certain packets. For example, the routing procedures may be modified to provide selective packet routing according to the methods described in U.S. Provisional Patent No. 61/107,272.

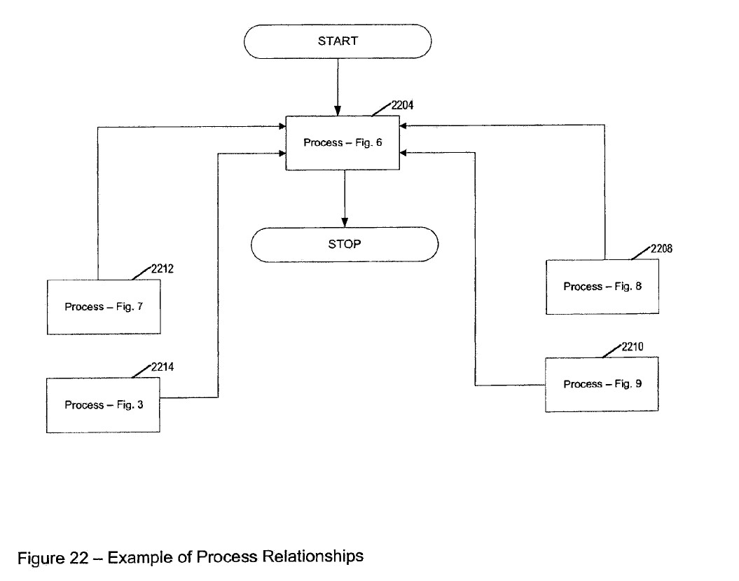

FIG. 22 is a block diagram illustrating the process relationships of a particular embodiment. As described with respect to FIG. 6, the process 2204 enables methods of information and message distribution. As described with respect to FIG. 7, the process 2212 enables methods of topological reevaluation for use in the message distribution of process 2204. As described with respect to FIG. 3, the process 2214 enables methods of radio signal evaluation, and creation of virtual network adjacencies, for use in the message distribution of process 2204. As described with respect to FIG. 8, the process 2208 enables methods of message advertising or transmission, for use in the message distribution of process 2204. As described with respect to FIG. 9, process 2210 enables methods of message hop count modification, for use in the message distribution of process 2204.

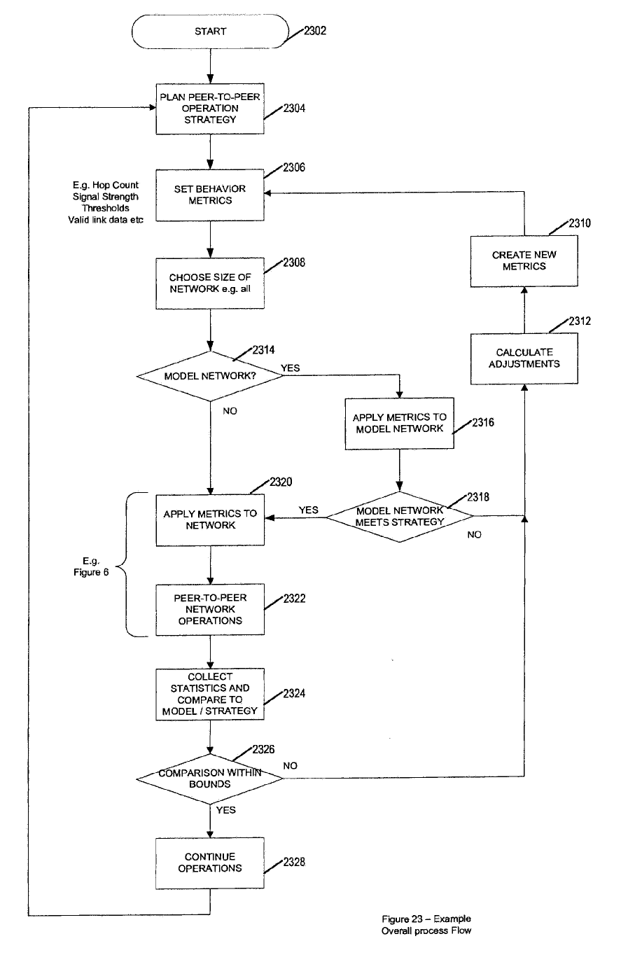

FIG. 23 is a process flow illustrating a method of network creation within the operational processes typically found in the mobile operator according to an embodiment of the invention. At step 2304, a peer-to-peer operational strategy is planned. For example, an application might consist of a number of customers deploying subnetworks, each customers deploying their subnetwork within their building, where the subnetworks are connected to form a citywide network. In this example, an operational strategy might be such that each subnetwork prefers data transmissions originating within the particular subnetwork, while maintaining an operational network.

After the operational strategy has been planned, behavioral metrics are set in process 2306. These behavioral metrics may be chosen according to the particular operational strategy. In the example deployment, a behavioral metric might comprise a preferential weighting factor given by each subnetwork device to its fellow subnetwork devices. In some embodiments, a network may be configured such that the behavioral metrics may be distributed to a subset of the network. For example, a new operational strategy might be tested in a proper subset of the subnetworks. In these embodiments, the size of the portion of the network that will be receiving the new behavior metrics may be chosen in step 2308.

In some embodiments, the network behavior may be modeled prior to actual application to the network. In these embodiments, a modeled network may be provided with the proposed behavior metrics. This model network may be evaluated at a particular time, or may be modeled for a time interval or plurality of time intervals. If a model network fails to meet the operational strategy, adjustments to the behavioral metrics may be computed in steps 2312 and 2310. This modeling procedure may be repeated as necessary to achieve the operational strategy, or to minimize the deviation from the operational strategy. If the model indicates that the strategy is met, or if the modeling step is not taken, in step 2320 the metrics are applied to the network.

In some embodiments, the application of the metrics to the network 2320 and the peer-to-peer network operations 2322 occur as described with respect to FIG. 6. In further embodiments, step 2324 is performed to collect network statistics from the network and to compare the statistics to a modeled statistics, or the statistics desired from the operational strategy. If desired, the behavioral metrics may be adjusted, as in steps 2312 and 2310, to adjust performance of the network. If the network is performing as desired, network operations may continue until a new operational strategy is implemented.

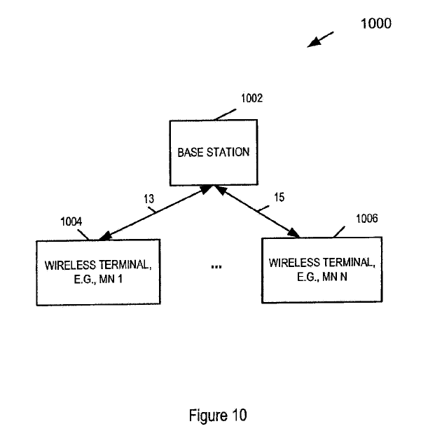

FIG. 10 illustrates a communications system 1000 implemented in accordance with one exemplary embodiment of the invention. In the system 1000, multiple wireless terminals, e.g., mobile nodes MN 1 (1004) through MN N (1006) communicate with a base station 1002, e.g., a femtocell, through the use of communication signals 13, 15. While illustrated as mobile nodes, the wireless terminals may also include stationary devices. Each mobile terminal may correspond to a different mobile user and are therefore sometimes referred to as user terminals. The signals 13, 15 may be, for example, CDMA or OFDM signals. In particular embodiments, the base station 1002 and mobile stations 1004, 1006 each implement the methods described herein. Accordingly, signals 13 and 15 may represent messages and data transferred as described herein.

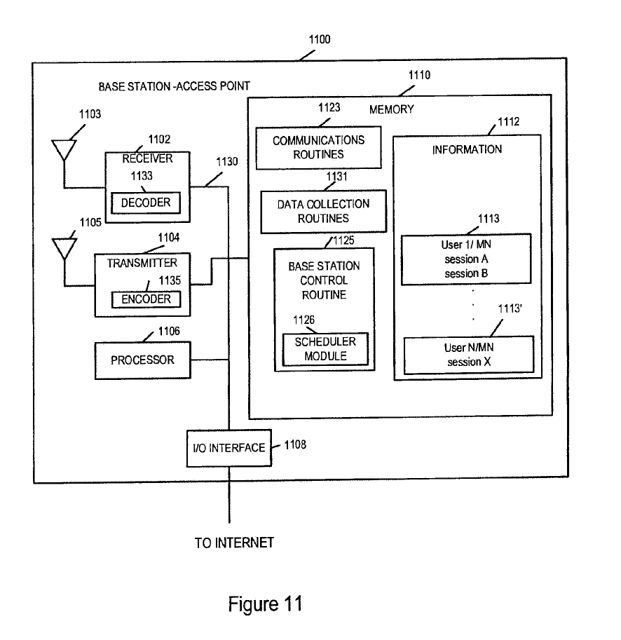

FIG. 11 illustrates an alternative base station in accordance with an embodiment of the invention. Base station 1100 may comprise, for example, an access router, a femtocell controller, or an integrated femtocell and controller. The base station 1100 includes antennas 1103, 1105 and receiver transmitter circuitry 1102, 1104. The receiver circuitry 1102 includes a decoder 1133 while the transmitter circuitry 1104 includes an encoder 1135. The circuitry 1102, 1104 is coupled by a bus 1130 to an I/O interface 1108, processor (e.g., CPU) 1106 and memory 1110. The I/O interface 1108 couples the base station 1100 to the internet and/or an the IP network. The memory 1110 includes routines that cause the base station 1100 to operate in accordance with embodiments of the invention when executed by the processor 1106. The memory 1110 also includes communications routines 1123 to cause base station 1100 to perform various communications operations and implement various communications protocols. The memory 1110 also includes a base station/femtocell control routine 1125 used to implement the methods described herein. The base station control routine 1125 further includes a scheduling module 1126 used to control transmission scheduling and/or communication resource allocation. Accordingly, module 1126 may serve as a scheduler. Memory 1110 also includes information used by communications routines module 1123 and control routine module 1125. The information 1112 includes an entry for each active mobile station user 1113, 1113′ which lists the active sessions being conducted by the user and includes information identifying the mobile station (MN) being used by a user to conduct the sessions. Module 1131 represents the data store and information collection that can occur within the access point that can be communicated to other elements or network equipment according to communication routines in module 1123.

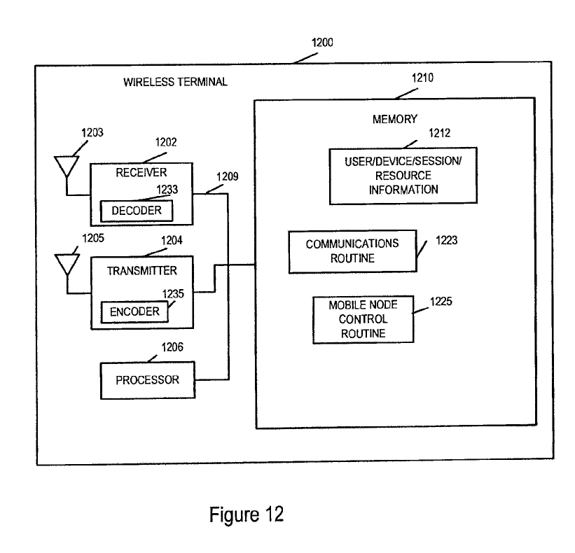

FIG. 12 illustrates an exemplary wireless terminal 1200, e.g., a mobile node (MN) implemented in accordance with an embodiment of the invention. For example, the mobile nodes described with respect to FIG. 10 may comprise such a wireless terminal. The mobile node 1200 includes receiver and transmitter antennas 1203, 1205 coupled to receiver and transmitter circuitry 1202, 1204 respectively. The receiver circuitry 1202 includes a decoder 1233 while the transmitter circuitry 1204 includes an encoder 1235. The receiver transmitter circuits 1202, 1204 are coupled by a bus 1209 to a memory 1210. Processor 1206, under control of one or more routines stored in memory 1210 causes the mobile node 1200 to operate in accordance with embodiments of the present invention as described above. In order to control mobile node operation memory includes communications routine 1223, and mobile node control routine 1225. The mobile node routine is responsible for insuring that the mobile node operates in accordance with embodiments of the present invention and performs the steps described above in regard to mobile node operations. The memory 1210 also includes user/device/session/resource information 1212 which may be accessed and used to implement the methods of the present invention and/or data structures used to implement the invention.

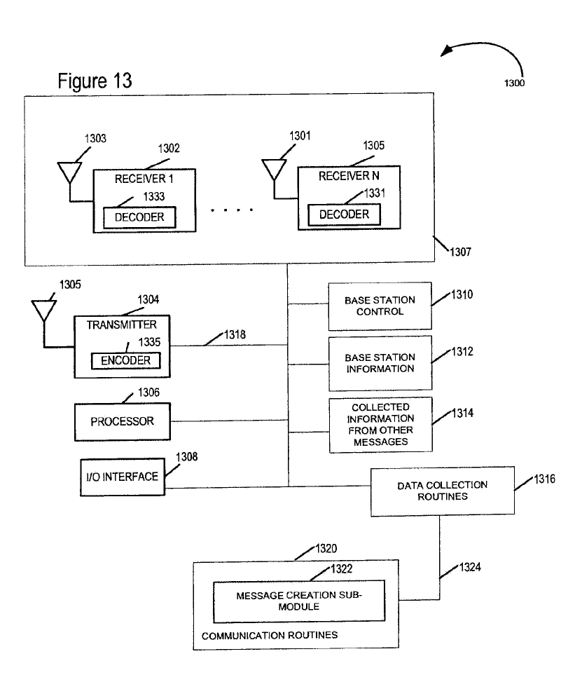

FIG. 13 illustrates an exemplary intermediate network device according to an embodiment of the invention. Intermediate network device 1300 is configured to receive messages from a plurality of other network devices through receivers 1 through N, 1302, 1305. For example, intermediate network device 1300 may receive a plurality of messages from a number of multiple nodes described herein with respect to FIG. 12. Intermediate network device 1300 is further configured to generate a message, such as message 2140 as described with respect to FIG. 21, and to transmit that message using transmitter 1304 to a further network device. For example, intermediate network device 1300 may transmit the message to an exterior entity, such as a gateway, or to another network device, such as a second intermediate network device.

The techniques of various embodiments may be implemented using software, hardware and/or a combination of software and hardware. Various embodiments are directed to apparatus, e.g., mobile nodes such as mobile access terminals, base stations including one or more attachment points, and/or communications systems. Various embodiments are also directed to methods, e.g., method of controlling and/or operating mobile nodes, base stations and/or communications systems, e.g., hosts. Various embodiments are also directed to machine, e.g., computer, readable medium, e.g., ROM, RAM, CDs, hard discs, etc., which include machine readable instructions for controlling a machine to implement one or more steps of a method.

In some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s). Some embodiments are directed to a device, e.g., communications device, including a processor configured to implement one, multiple or all of the steps of one or more methods of the invention.

Some embodiments are directed to a computer program product comprising a computer-readable medium comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium such as a RAM (Random Access Memory), ROM (Read Only Memory) or other type of storage device. As such, the computer-readable medium of certain disclosed embodiments can be non-transitory and/or non-transmissible computer-readable media. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

In some embodiments, the processor or processors, e.g., CPUs, of one or more devices, e.g., communications devices such as wireless terminals are configured to perform the steps of the methods described as being as being performed by the communications device. Accordingly, some but not all embodiments are directed to a device, e.g., communications device, with a processor which includes a module corresponding to each of the steps of the various described methods performed by the device in which the processor is included. In some but not all embodiments a device, e.g., communications device, includes a module corresponding to each of the steps of the various described methods performed by the device in which the processor is included. The modules may be implemented using software and/or hardware.

At least some of the methods and apparatus of various embodiments are applicable to a wide range of communications systems including many OFDM as well as non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between access nodes and mobile nodes. In some embodiments the access nodes are implemented as base stations which establish communications links with mobile nodes using OFDM and/or CDMA. In various embodiments the mobile nodes are implemented as notebook computers, personal data assistants (PDAs), or other portable devices including receiver/transmitter circuits and logic and/or routines, for implementing the methods.

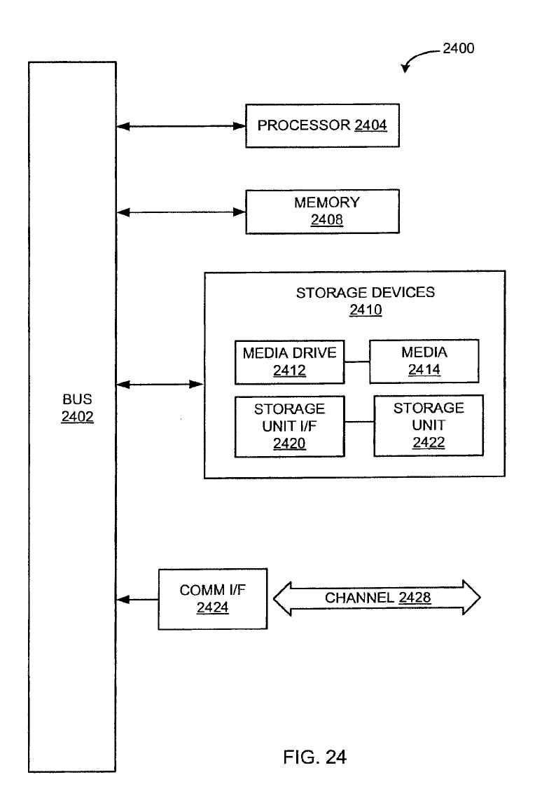

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example-computing module is shown in FIG. 24. Various embodiments are described in terms of this example-computing module 2400. After reading this description, it will become apparent to a person skilled in the relevant art how to implement the invention using other computing modules or architectures.

Referring now to FIG. 24, computing module 2400 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 2400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 2400 might include, for example, one or more processors, controllers, control modules, or other processing devices, such as a processor 2404. Processor 2404 might be implemented using a general-purpose or special-purpose processing engine such as, for example, a microprocessor, controller, or other control logic. In the example illustrated in FIG. 24, processor 2404 is connected to a bus 2402, although any communication medium can be used to facilitate interaction with other components of computing module 2400 or to communicate externally.

Computing module 2400 might also include one or more memory modules, simply referred to herein as main memory 2408. For example, preferably random access memory (RAM) or other dynamic memory, might be used for storing information and instructions to be executed by processor 2404. Main memory 2408 might also be used for storing temporary variables or other intermediate information during execution of instructions to be executed by processor 2404. Computing module 2400 might likewise include a read only memory (“ROM”) or other static storage device coupled to bus 2402 for storing static information and instructions for processor 2404.

The computing module 2400 might also include one or more various forms of information storage mechanism 2410, which might include, for example, a media drive 2412 and a storage unit interface 2420. The media drive 2412 might include a drive or other mechanism to support fixed or removable storage media 2414. For example, a hard disk drive, a floppy disk drive, a magnetic tape drive, an optical disk drive, a CD or DVD drive (R or RW), or other removable or fixed media drive might be provided. Accordingly, storage media 2414, might include, for example, a hard disk, a floppy disk, magnetic tape, cartridge, optical disk, a CD or DVD, or other fixed or removable medium that is read by, written to or accessed by media drive 2412. As these examples illustrate, the storage media 2414 can include a computer usable storage medium having stored therein computer software or data.

In alternative embodiments, information storage mechanism 2410 might include other similar instrumentalities for allowing computer programs or other instructions or data to be loaded into computing module 2400. Such instrumentalities might include, for example, a fixed or removable storage unit 2422 and an interface 2420. Examples of such storage units 2422 and interfaces 2420 can include a program cartridge and cartridge interface, a removable memory (for example, a flash memory or other removable memory module) and memory slot, a PCMCIA slot and card, and other fixed or removable storage units 2422 and interfaces 2420 that allow software and data to be transferred from the storage unit 2422 to computing module 2400.

Computing module 2400 might also include a communications interface 2424. Communications interface 2424 might be used to allow software and data to be transferred between computing module 2400 and external devices. Examples of communications interface 2424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 2424 might typically be carried on signals, which can be electronic, electromagnetic (which includes optical) or other signals capable of being exchanged by a given communications interface 2424. These signals might be provided to communications interface 2424 via a channel 2428. This channel 2428 might carry signals and might be implemented using a wired or wireless communication medium. These signals can deliver the software and data from memory or other storage medium in one computing system to memory or other storage medium in computing system 2400. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to physical storage media such as, for example, memory 2408, storage unit 2420, and media 2414. These and other various forms of computer program media or computer usable media may be involved in storing one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 2400 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
collecting radio data from a first peer device;
collecting topological data from the first peer device or a second peer device;
creating a message from the topological and the radio data; and
sending the message to a network device.

2. The method of claim 1, wherein the network device to which the message is sent is the first or the second peer device.

3. The method of claim 1, wherein the network device to which the message is sent is a third peer device.

4. The method of claim 1, wherein the sending comprises sending the message to a plurality of network devices.

5. The method of claim 1, further comprising obtaining a behavior metric, and wherein the creating the message comprises evaluating the behavior metric.

6. The method of claim 5, wherein the behavior metric is determined pursuant to an operation strategy.

7. The method of claim 5, wherein the obtaining comprises deriving the behavior metric.

8. The method of claim 5, wherein the obtaining comprises receiving the behavior metric.

9. The method of claim 1, wherein the radio data comprises at least one of a radio link data and a radio signal data.

10. The method of claim 9, wherein the topological data comprises data derived from a message provided by at least one of:
a peer device of the first or the second peer device; and
a topologically-farther device.

11. The method of claim 10, further comprising discarding some of the radio or the topological data pursuant to a rule.

12. The method of claim 1, wherein the message comprises data regarding at least one of:
a received radio data;
an intrinsic radio capability;
a received topological data; or
an intrinsic topological capability.

13. The method of claim 12, wherein the intrinsic topological capability or the intrinsic radio capability comprise at least one of:
a current or anticipated operational data;
a current or anticipated operational system load;
a current or anticipated transmission data; or
a current or anticipated transmission bandwidth.

14. The method of claim 12, further comprising obtaining an address based on the message.

15. The method of claim 14, further comprising:
obtaining a routing procedure based on the address and received network device addresses; and
sending a transmission based on the routing procedure.

16. The method of claim 15, wherein obtaining the routing procedure comprises generating a weighted table of network device data.

17. The method of claim 15, wherein obtaining the routing procedure comprises receiving the routing procedure from a network device, wherein the network device maintains a weighted table of network device data.

18. The method of claim 5, further comprising monitoring one or more devices within the network and modifying the behavior metric pursuant to a strategy.

19. A device, comprising:
a transmitter;
a receiver;
a controller coupled to the receiver and configured to receive peer device radio data and peer device network data; and further configured to cause the transmitter to communicate radio capability data and topological network data to at least one other network device.

20. The device of claim 19, wherein the at least one other network device is a peer device.

21. The device of claim 19, wherein the at least one other network device is a plurality of network devices.

22. The device of claim 19, wherein the controller is further configured to apply a behavior metric to transmit the radio capability data and the topological network data.

23. The device of claim 22, wherein the application of the behavior metric comprises discarding a portion of the radio capability data or the topological network data pursuant to a rule.

24. The device of claim 19, wherein the radio capability data and the topological network data are encoded in a message having a format.

25. The device of claim 24, wherein the controller is further configured to receive a plurality of messages encoded with network data from a plurality of other network devices and to transmit the message to at least one further network device.

26. The device of claim 25, wherein the at least one further network device is an exterior entity.

27. The device of claim 26, wherein the exterior entity is a gateway.

28. The device of claim 19, wherein the controller is further configured to obtain an address and to obtain addresses of other network devices.

29. The device of claim 28, wherein the controller is further configured to obtain a routing procedure based on the radio data and the network data.

30. The device of claim 29, wherein the controller is further configured to provide the routing procedure to a network device.

31. The device of claim 19, wherein the controller is further configured to receive a routing procedure.

32. A system, comprising:
a plurality of network devices, wherein a network device is configured to:
collect radio data from a first peer device;
collect topological data from the first peer device or a second peer device;
create a message from the topological and the radio data; and
send the message to a further network device.

33. The system of claim 32, wherein the further network device is the first or the second peer device.

34. The system of claim 32, wherein the network device is configured to send the message to a plurality of other network devices.

35. The system of claim 32, further comprising:
an intermediate network device configured to receive a plurality of messages encoded with network data from a plurality of other network devices and to transmit the message to at least one further network device.

36. The system of claim 32, further comprising:
at least one exterior entity in communication with at least one of the plurality of network devices and configured to enable the network system to communicate with an exterior network.

37. The system of claim 36, wherein the exterior entity is a gateway.

38. The system of claim 32, wherein the plurality of network devices are further configured to obtain an address and to obtain addresses of other network devices.

39. The system of claim 38, wherein at least one of the plurality of network devices is further configured to create a routing procedure based on received messages pursuant to a behavior metric.

40. The system of claim 39, wherein the network device or devices configured to create a routing procedure are further configured to transmit the created routing procedure to the remaining network devices of the network system.

41. The system of claim 32, wherein the network device is configured to evaluate a behavior metric to create the message.

42. The system of claim 41, wherein the behavior metric is defined to evaluate operational behavior for conformance with an operational strategy.

43. The system of claim 42, wherein the behavior metric is provided to a subset of the plurality of network devices.

44. The system of claim 43, wherein the behavior metric is applied to the subset to determine conformance with the operational strategy; and wherein the behavior metric is adjusted or provided to further network devices pursuant to the result of the evaluation.

45. A computer program product comprising computer program code embodied in a computer useable medium and enabling a network device to perform the functions of:
collecting radio data from a first peer device;
collecting topological data from the first peer device or a second peer device;
creating a message from the topological and the radio data; and
sending the message to a network device.

46. The computer program product of claim 45 further enabling a network device to receive a behavior metric, and wherein the creating comprises applying the metric.

47. The computer program product of claim 45 further enabling a network device to obtain an address based on the message.

48. The computer program product of claim 47 further enabling a network device to:
obtain a routing procedure based on the address and received network device addresses; and
send a transmission based on the routing procedure.

49. The computer program product of claim 48, wherein obtaining the routing procedure comprises receiving the routing procedure from a network device, wherein the network device maintains a weighted table of network device data.

50. A method of modeling a network, comprising:
obtaining radio data of a first peer device;
obtaining topological data of the first peer device or a second peer device;
obtaining a behavior metric; and
applying the behavior metric to the radio data and the topological data to create a model of the network.

51. The method of claim 50, further comprising, evaluating the model pursuant to an operation strategy.

52. The method of claim 51, further comprising:
adjusting the behavior metric pursuant to the results of the evaluation; and
applying the adjusted behavior metric to the radio data and the topological data to create a second model of the network.

53. The method of claim 51, further comprising providing the behavior metric to a network device.

54. The method of claim 50, further comprising obtaining an address of the first or the second peer device.

55. The method of claim 54, further comprising generating a routing procedure for the model.

56. The method of claim 55, further comprising providing the routing procedure to a network device.
